(19) United States
(12) Patent Application Publication
(10) Pub. No.: US 2020/0134728 A1
(43) Pub. Date: Apr. 30, 2020

(54) System and Method for Assisting Insurance Services Providers to Determine an Insurance Eligibility Status of a Roof

(71) Applicant: Alexander Vickers, Addison, TX (US)

(72) Inventor: Alexander Vickers, Addison, TX (US)

(21) Appl. No.: 16/176,873

(22) Filed: Oct. 31, 2018

(51) Int. Cl. G06Q 40/08; G06Q 10/00; G06Q 50/08; G06T 7/00; G06F 15/18

(52) U.S. Cl. CPC G06Q 40/08; G06Q 10/20; G06Q 50/08; G06T 7/001; G06T 2207/20081; G06T 2207/30161; G06T 2207/10016; G06T 2207/10032; G06F 15/18

(57) ABSTRACT

A system and method for assisting an insurance service provider to process an insurance request for a roof associated with a building includes the steps of receiving a request for insuring the roof, followed by launching an application for identifying information related to the roof within a selected period of time and utilizing the application to analyze a series of time-lapse images of the roof obtained from past and real-time satellite images of the geographical area. The series of time-lapse images of the roof provides information related to the roof including roof characteristics and other past and present damages and maintenance related information associated with the roof. Comparing sequential changes in a number of pixels in the series of time-lapse images provides the maintenance and damages related information. The insurance service provider compares the above information with preset roof conditions to determine the insurance eligibility status of the roof.

### BACKGROUND

### Technical Field

The disclosed principles relate generally to automated systems and methods for assisting the insurance service providers to determine insurance eligibility status of a roof. More specifically, the disclosed principles relate to automated systems and methods for determining the past and present information related to a roof relevant for determining the insurance eligibility status of the roof.

### Description of the Related Art

Property insurance is a common form of insurance used to insure properties such as, but not limited to, buildings, facilities and other forms of material properties. Certain insurance service providers allow insuring the building parts such as, but not limited to the roof of the building, and other parts of the building structure. In some cases, the building insurance covers the roof and other structural parts and interior objects in the buildings. In all such cases, the insurance service providers perform detailed inspection of the building including its interior and exterior parts such as the roof of the building prior to the grant of the insurance coverage. There are several methods employed by the insurance service providers to inspect the buildings prior to its insurance coverage, one such method is manual inspection of the parts of the building. Insurance companies spend considerable amounts of resources and time to inspect the building prior to grant of its insurance coverage. For example, an estimator is required on site for inspection of each shingles of a large building roof to determine the extent of damage to the roof, the present condition of the roof and to determine whether the roof needs to be replaced or repaired prior to the allowance of the insurance coverage. Hence, the time and resources required for the manual inspection of the roof of the buildings and other roof parts is large, which leads to delays and improper handling of the insurance coverage requests by the insurance services provider.

Another type of building roof inspection is using drones or other remotely controlled machines to inspects the parts of the roof to determine the extent of damage to the roof, the present condition of the roof and to determine whether the roof needs to be replaced or repaired prior to the allowance of the insurance coverage. These remotely operated devices are controlled by a person associated with the insurance service provider on site and control the device to inspect the whole area of the roof. In a similar method, the operator associated with the insurance services providers inspects the roof using drones, which captures images of the roof that are manually analyzed by the insurance services provider to determine the insurance eligibility status of the roof. This process is again time consuming as the manual inspection of the images of the roof takes time and is not perfect as the manual analysis may sometimes miss the damages on certain parts of the roof, which are not properly visible from the images of the roof. Furthermore, the above types of inspections do not take into account the past condition of the roof, such as the damages and maintenance activities performed on the roof prior to the insurance request, which is also important in determining the insurance eligibility status of the roof. There are several prior arts related to the determination of insurance eligibility status of the roof, which are hereby incorporated by reference for their supportive teachings of the disclosed principles.

U.S. Patent App. No. 20150302529 A1 titled “Roof Condition Evaluation And Risk Scoring System And Method” filed by Marshall & Swift/boeckh LLC discloses systems and methods for determining a risk indicator for the condition of a roofing system of a building. The system may include an interface configured to receive at least one input regarding the building, roofing system, location of the building roofing system, location-specific weather data, historical building performance data, or data extracted from imagery. The system includes a roof condition risk scoring engine configured to receive the input through the interface and to apply the input using a probabilistic roof model to calculate an indicator for a probability of loss associated with the roofing system replacement or reconstruction cost. The probability can be scaled into a roof condition risk score, e.g., a numeric score, a grade, a quality rating, etc. The system is also configured to determine an indicator of probability or risk of a roof of a building needing to be repaired, a roof of a building needing to be replaced, and an insurance claim being made by a holder of an insurance policy insuring the roof of a building. The teachings of the above prior art can be utilized by the insurance service providers to determine the present condition of the roof, however, it cannot be utilized for determining the insurance eligibility status of the roof as the prior art not focuses on the past and present condition, damages and maintenance related information of the roof relevant for determining its insurance eligibility status.

Another prior art U.S. Pat. No. 9,262,564 titled “Method Of Estimating Damage To A Roof” issued to State Farm Mutual Automobile Insurance Co. discloses a system and a method for estimating damage to a roof. The method includes the steps of generating, from a first point cloud representing a roof, a second point cloud representing a shingle. The system and method further includes comparing the second point cloud to a model point cloud, the model point cloud representing a model shingle. The method also includes identifying, based on the comparison, a first set of points, correlating each point within the first set of points to a representation of a point of damage. The system and method includes identifying a second set of points, the second set of points including at least one point from the first set, correlating the second set of points to a representation of a damaged region of the roof. Further, the method includes generating and storing to a memory a report based on the second set of points for subsequent retrieval and use in estimating damage to at least part of the roof. A damage assessment module operating on a computer system automatically evaluates a roof, estimating damage to the roof by analyzing a point cloud of a roof. The damage assessment module identifies individual shingles from the point cloud and detects potentially damaged areas on each of the shingles. The damage assessment module then maps the potentially damaged areas of each shingle back to the point cloud to determine which areas of the roof are damaged. Based on the estimation, the damage assessment module generates a report on the roof damage.

Yet another prior art is U.S. Pat. No. 9,613,538 titled “Unmanned Aerial Vehicle Rooftop Inspection System” issued to Unmanned Innovation Inc. which discloses methods, systems, and apparatus, including computer programs encoded on computer storage media, for an unmanned aerial system inspection system. One of the methods is performed by an unmanned aerial vehicle (UAV) and includes receiving, by the UAV, flight information describing a job to perform an inspection of a rooftop. The UAV ascends to a particular altitude and an inspection of the rooftop is performed including obtaining sensor information describing the rooftop. Location information identifying a damaged area of the rooftop is also received. An inspection of the damaged area of the rooftop is performed including obtaining detailed sensor information describing the damaged area. The disclosed principles utilizes the unmanned aerial vehicle (UAV) to schedule inspection jobs and to perform inspections of potentially damaged properties e.g., a home, an apartment, an office building, a retail establishment, etc. By intelligently scheduling jobs, a large area can be inspected using UAV(s), which reduces the overall time of inspection, and enables property to be maintained in safer conditions. Furthermore, by enabling an operator to intelligently define a safe flight plan of a UAV, and enable the UAV to follow the flight plan and intelligently react to contingencies, the risk of harm to the UAV or damage to surrounding people and property can be greatly reduced.

### SUMMARY

The disclosed principles relate to a computer assisted system and associated method for assisting an insurance service provider to process an insurance request for a roof associated with a building within a geographical area. All the above systems and methods can be utilized to identify the damages to the roofs by random inspection of the roofs at any particular date or a selected time. However, such methods cannot be utilized for determining the insurance eligibility status of the roof as the prior arts do not focuses on the past and present conditions, damages and maintenance related information of the roof relevant for determining its insurance eligibility status. Hence, there exists a need for a system and method for assisting the insurance services providers to accurately determine the insurance eligibility status of the roof of buildings by analyzing the past and present roof characteristics, and other past and present damages and maintenance related information of the roof relevant for determining its insurance eligibility status of the roof. The needed system would also allow the insurance service providers to suggest a number of changes such as maintenance activities on the roof prior to the allowance of the insurance coverage.

Exemplary methods for processing the insurance request for the roof includes the steps of receiving a request for insuring the roof associated with a building, followed by launching an application for identifying a variety of information related to the roof within a selected period of time using an electronic computing device and utilizing the application to analyze a number of images of the roof obtained from a series of time-lapse images of the past and real-time satellite images of the geographical area. As used herein, any reference to images or imaging includes any and all imaging technologies, and any images resulting therefrom, using any type of imaging technology either now existing or later developed. The series of time-lapse images are captured over the selected period of time, which when processed using the above application provides the following information related to the roof including a variety of roof characteristics associated with the roof and one or more damages and maintenance related information associated with the roof within the selected period of time. The insurance service provider can further analyze the above information, either manually or automatically using a third party application, to determine an insurance eligibility status of the roof.

In some instances, the present methods utilize the artificial intelligence (AI)-based instructions of the application to identify the roof characteristics by comparing a number of features identified from the series of time-lapse images of the roof to a number of predefined roof features associated with a number of roof types stored in a dynamically updated database of the application. In some instances, the roof characteristics identified from the images of the roof includes a roof type, an age of the roof, at least one roof material, at least one roof dimension, at least one material covering the roof, at least one pre-existing roof damage related information and at least one maintenance information prior to the selected period of time and other related roof information relevant for determining the insurance eligibility status of the roof. The maintenance-related information and the damage related information associated with the roof is identified using the artificial intelligence-based instructions of the application by comparing a number of sequential changes in a number of pixels in the series of time-lapse images and a number of changes in the roof characteristics identified from the series of time-lapse images of the roof and correlating with the weather activities capable of damaging the roof during the selected period of time.

The insurance service provider can compare the information related to the roof obtained from the application with a number of preset roof conditions for determining the insurance eligibility status of the roof. The application allows an automated and a manual identification of the information related to the roof from the images captured prior to and after the weather activities for identifying the insurance eligibility status of the roof. The insurance eligibility status of the roof is identified by a manual visual inspection and/or an automated comparison of the information related to the roof obtained from the application with the preset roof conditions using the artificial intelligence-based instructions of the application. The comparison of the information related to the roof obtained from the application with the preset roof conditions enables the insurance service provider to suggest a number of maintenance actions to the roof prior to approving the roof insurance request.

The disclosed principles also relate to computer-implemented systems for assisting the insurance service providers to process an insurance request for a roof associated with a building within a geographical area. Such systems include an electronic computing device having a memory unit to store instructions of an application for identifying the information related to the roof, within a selected period of time, and a processor configured to execute the instructions of the application to perform a number of tasks including obtaining the images of the roof in the geographical area, wherein the images of the roof includes a series of time-lapse images of the roof, obtained from a number of past and real-time satellite images of the geographical area, captured over the selected period of time. The application further collects the weather data during the selected period of time from a weather data service provider and processes with the images of the roof using the artificial intelligence-based instructions to identify the information related to the roof including the roof characteristics associated with the roof and other maintenance and damage related information associated with the roof within the selected period of time. The insurance eligibility status of the roof is determined by comparing the information related to the roof obtained from the application with a number of preset roof conditions.

Other features of the disclosed principles are discussed below. The disclosed principles are designed to fulfill the below and other additional features as detailed in the following claims section and detailed description section of the present disclosure.

One feature of the disclosed principles provides a computer-implemented method for assisting the insurance service providers to determine an insurance eligibility status of a roof associated with a building.

Another feature of the disclosed principles provides a computer-implemented system for assisting the insurance services providers to determine the insurance eligibility status of a roof of a building instantly without site inspection.

Another feature of the disclosed principles provides an electronic computing device running an application for identifying the past and present conditions of a roof, obtained from past and present satellite images of the geographical area, relevant for determining the insurance eligibility status of a roof.

Another feature of the disclosed principles provides an electronic computing device running an application for identifying roof characteristics including roof type, material, age, past and present damages and maintenance related information and other relevant information associated with a roof requesting for insurance coverage.

Another feature of the disclosed principles provides an provides an electronic computing device running an artificial intelligence-based application for identifying the past and present damages and maintenance activities on the roof, requesting for insurance coverage, caused by severe weather activities in the geographical area.

Another feature of the disclosed principles provides a system having an electronic computing device running an artificial intelligence-based application for transforming the images of the roof, which is requesting for insurance coverage, through a series of steps including image pixilation to identify the past and present damages and maintenance activities on the roof relevant for determining the insurance eligibility status of the roof.

Another feature of the disclosed principles provides an artificial intelligence-based application with a dynamic graphical user interface for allowing the insurance services providers to manually analyze the roof, which is requesting for insurance coverage, and determine the insurance eligibility status of the roof.

Another feature of the disclosed principles provides a method for assisting the insurance series providers to suggest a number of maintenance activities to the roof prior to the grant of insurance coverage.

These, together with other features of the disclosed principles, along with the various features of novelty, which characterize the disclosed principles, are pointed out with particularity in the disclosure. For a better understanding of the disclosed principles, its operating advantages and the specific objects attained by its uses, reference should be had to the accompanying drawings and descriptive matter in which there are illustrated exemplary embodiments of the disclosed principles. In this respect, before explaining at least one embodiment of the disclosed principles in detail, it is to be understood that the disclosed principles are not limited in its application to the details of construction and to the arrangements of the components set forth in the following description or illustrated in the drawings. The disclosed principles are capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

To further clarify various aspects of some example embodiments of the disclosed principles, a more particular description of the disclosed principles will be rendered by reference to specific embodiments thereof that are illustrated in the appended drawing. It is appreciated that the drawing depicts only illustrated embodiments of the disclosed principles and are therefore not to be considered limiting of its scope. Elements in the figures have not necessarily been drawn to scale in order to enhance their clarity and improve understanding of these various elements and embodiments of the disclosed principles. Furthermore, elements that are known to be common and well understood to those in the industry may not be depicted in order to provide a clear view of the various embodiments of the disclosed principles, thus the drawings are generalized in form in the interest of clarity and conciseness. The disclosed principles will be described and explained with additional specificity and detail through the use of the accompanying drawing in which:

FIG. 1 illustrates a schematic diagram of a system for assisting an insurance services provider to process an insurance request for one or more roofs associated with a building within a geographical area, according to an exemplary embodiment of the disclosed principles;

FIG. 2 is a flowchart showing a number of steps of a computer assisted method for assisting an insurance services provider to process an insurance request for one or more roofs associated with a building within a geographical area, according to an exemplary embodiment of the disclosed principles;

FIG. 3 illustrates another flowchart showing a number of operating steps of the present application for assisting the insurance service provider to process the insurance request for insuring a roof associated with a building, according to an embodiment of the disclosed principles;

FIG. 4 illustrates a block diagram showing a number of hardware and software components of the electronic computing device configured to run an application for assisting an insurance service provider to process an insurance request for a roof associated with a building within a geographical area, according to an embodiment of the disclosed principles;

FIG. 5 is an exemplarary flowchart showing the image processing, image conversion and analysis steps of the series of time-lapse images of the roof, captured over the selected period of time, to collect the information related to the past and present conditions of the roof relevant for determining the insurance eligibility status of the roof, according to an embodiment of the disclosed principles;

FIG. 6 is a schematic diagram showing the automated operation of determination of insurance eligibility status of the roof, according to an embodiment of the disclosed principles;

FIG. 7 is a chart showing the details of the hailstorm activities over a particular area and the hailstone sizes during the particular hailstorm activity, according to an exemplary embodiment of the disclosed principles;

FIG. 8 is an exemplarary image of a pair of roofs obtained from the series of time-lapse images captured from the past satellite images of the selected building facility within the selected geographical area, according to an exemplarary embodiment of the disclosed principles;

FIG. 9 is an exemplarary image of the pair of roofs shown in FIG. 8, obtained from the series of time-lapse images captured from the present satellite images of the selected geographical area, according to an exemplarary embodiment of the disclosed principles; and

FIG. 10 to FIG. 12 shows exemplarary images of a roof, requesting for insurance coverage with the insurance service provider, obtained from satellite images of the selected geographical area taken over a period of time, according to an exemplarary embodiment of the disclosed principles.

### DETAILED DESCRIPTION

In the following discussion that addresses a number of embodiments and applications of the disclosed principles, reference is made to the accompanying drawings that form a part hereof, and in which is shown by way of illustration specific embodiments in which the disclosed principles may be practiced. It is to be understood that other embodiments may be utilized and changes may be made without departing from the scope of the disclosed principles. The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

Further, various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. The following embodiments and the accompanying drawings, which are incorporated into and form part of this disclosure, illustrate one or more embodiments of the disclosed principles and together with the description, serve to explain the disclosed principles. To the accomplishment of the foregoing and related ends, certain illustrative aspects of the disclosed principles are described herein in connection with the following description and the annexed drawings. These aspects are indicative, however, of but a few of the various ways in which the disclosed principles can be employed and the disclosed principles are intended to include all such aspects and their equivalents. Other advantages and novel features of the disclosed principles will become apparent from the following detailed description of the disclosed principles when considered in conjunction with the drawings.

Further, the following section summarizes some aspects of the present disclosure and briefly introduces some exemplary embodiments. Simplifications or omissions in this section as well as in the abstract or the title of this description may be made to avoid obscuring the purpose of this section, the abstract and the title. Such simplifications or omissions are not intended to limit the scope of the present disclosure nor imply any limitations.

The disclosed principles relate to systems and methods for assisting the insurance service providers to verify the eligibility of insurance requests from one or more property owners to insure their building roofs. The disclosed systems and associated methods utilize artificial intelligence-based image processing to identify a variety of information related to the roofs of the building over a selected period of time, which can be utilized by the insurance service providers for determining the insurance eligibility status of the roofs. The identification of the present and historical information related to the roofs within a selected prior of time enables the insurance services providers to identify important information related to the roofs such as maintenance information related to the roof over the selected prior of time, provides information related to any past damages to the roofs, and other relevant information, which is useful in determining the insurance eligibility status of the roofs. The present systems and associated methods further enable the insurance service providers to determine the damages caused to the roofs by harsh weather activities such as hailstorm, wind, rain and other weather activities with a selected period of time by analyzing the series of time-lapse image of the roofs obtained from the past and present satellite images of the geographical area captured within the selected period of time. In addition, the present systems and methods allow the insurance service providers to visualize the maintenance activities performed on the roofs after the severe weather activity events that have caused damages to the roofs. This further allows the insurance service providers to suggest the owners of the buildings to perform the relevant maintenance activities prior to applying the roofing insurance of the building. In addition, the present systems and methods enable the insurance services providers to set an insurance value based on the actual condition of the roofs. In some instances, the insurance service providers can utilize the information related to the roof collected during a desired period of time, using the present system, to grant or reject a request for insuring the roof of the building.

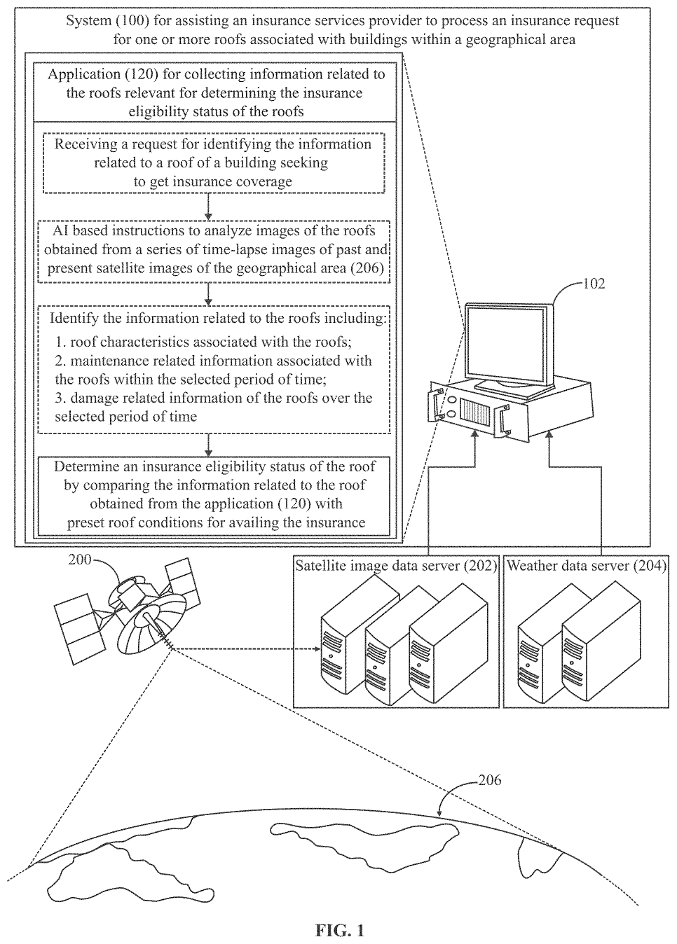

FIG. 1 illustrates a schematic diagram of a system 100 for assisting an insurance services provider to process an insurance request for one or more roofs associated with a building within a geographical area 206, according to an exemplary embodiment of the disclosed principles. The present system 100 for assisting the insurance services providers to determine the eligibility of roofs of buildings prior to insuring the roofs of the buildings includes an electronic computing device 102 configured to run an application 120 for collecting a variety of information related to the roofs, which are relevant for determining the insurance eligibility status of the roofs. In an advantageous embodiment of the present system 100, the electronic computing device 102 is a computer having a memory unit to store a number of instructions of the application 120 for collecting the information related to the roofs relevant for determining the insurance eligibility status of the roofs. In some instances, the application 120 collects the information related to the roofs, relevant for determining the insurance eligibility status of the roofs, using a number of artificial intelligence-based instructions of the application 120. In some instances, the artificial intelligence-based instructions of the application 120 is configured to be executed using one or more processor(s) of the electronic computing device 102. The artificial intelligence-based instructions of the application 120, when executed using the processor, enables the electronic computing device 102 to perform a number of tasks such as to collect a number of images of the roof, which is to be insured by the insurance service provider. In an exemplary embodiment of the disclosed principles, the images of the roofs of the buildings in a desired geographical area 206 is obtained from one or more aerial images covering the geographical area 206. As used herein, such images or image-capturing technology may encompass any and all imaging technologies, and any images resulting therefrom, using any type of imaging technology either now existing or later developed. Examples of such imaging technology may include infrared imaging, ultra-violet imaging, thermal imaging, or any one of a variety of multispectral imaging technologies.

In some instances, the images captured using the present application 120 includes a series of aerial images of the geographical area 206 obtained from one or more satellite images captured using one or more satellites 200 covering the particular geographical area 206. In some other instances, the present application 120 for collecting the information related to the roofs, relevant for determining the insurance eligibility status of the roofs, communicates directly with an aerial image capturing application launched from the electronic computing device 102 to generate the series of time-lapse images covering the roofs of the buildings in the selected geographical area(s). The aerial image capturing application launched from the electronic computing device 102 communicates with a remote satellite image data server 202 to retrieve the satellite images of the geographical area(s) 206. In some embodiments, the present application 120 running on the electronic computing device 102 allows a user to set a desired time period to receive the satellite images covering the geographical area(s) captured within the selected period of time. The images of the roof are collected from the series of time-lapse images of the roof obtained from the past and present satellite images covering the particular geographical area 206 involving the building associated with the roof. The instructions of the application 120, when executed using the processor, further enables the application 120 to perform a variety of image processing, data comparison and correlation steps to identify the variety of information related to roof or roofs under analysis. The insurance service providers can utilize this information related to the roof(s) to determine an insurance eligibility status of the roof.

In some instances, the information related to the roof, collected using the present application 120, includes a variety of roof characteristics associated with the roof, a number of maintenance related information associated with the roof and one or more damage related information of the roof. The insurance service providers can select the desired time period through a dynamic graphical user interface of the application 120 to obtain the past and present satellite images of the geographical area 206 covering the building with the roof under analysis. The images of the roof is made available in form of the series of the time-lapse images of the roof obtained from the past and present satellite images captured over the selected period of time. The series of the time-lapse images of the roof obtained during this time period, when analyzed using the artificial intelligence-based image processing instructions of the application 120, provides the information related the historical status, the present status and the series of changes to the roof during the selected time period. The insurance service providers can utilize this information related to the roof for either granting or rejecting the insurance coverage to the roof. In some instances, the insurance service providers can advise their clients, i.e. the building owners, to perform certain maintenance activities on the roof based on the information related to the roof collected using the present application 120 to avail the insurance coverage.

The artificial intelligence-based instructions of the present application 120 identifies the information related to the roofs, such as the roof characteristics and other maintenance and damage related information of the roof, which are occurred over the selected period of time. The insurance service provider can utilize the information related to the roofs either directly or through third party application to determine the insurance eligibility status of the roof. In one or more embodiments of the disclosed principles, the roof characteristics identified by processing the images of the roofs includes a roof type, an age of the roof, at least one roof material, at least one roof dimension, at least one roof maintenance related information, at least one pre-existing roof damage related information, at least one material covering the roof, and other related roof information. In some instances, execution of the artificial intelligence-based instructions of the application 120 identifies the roof characteristics by comparing a variety of features of the roofs identified from the series of time-lapse images of the roofs with a number of predefined roof features associated with different roof types stored in a dynamically updated roof characteristics database associated with the present application 120.

The artificial intelligence-based instructions of the present application 120 further identifies the past and present maintenance and other damaged related information of the roofs, prior to and during the selected period of time, which can further utilized by the insurance service providers to determine the insurance eligibility status of the roofs. In some embodiments, one or more severe weather activities occurred during the selected period of time causes one or more damages to the roofs. The damages on the roofs occurred during the selected period of time are identified by analyzing the series of time-lapse images of the roofs using the artificial intelligence-based instructions of the present application 120. The present application 120 communicates with a weather data server 204 to collect information related to the weather activities occurred on the particular geographical area 206 during the selected period of time. Further, the present application 120 correlates the roof characteristics of the roof identified from the images of the roof with the relevant weather data of the geographical area covering the roof, for the selected period of time, received from the weather data server 204 to identify the weather activities that have caused damages the roof. Thus, the application 120 running on the electronic computing device 102 enables the automated identification of one or more weather activities in the selected geographic area, within the selected period of time, capable of damaging the roof. In some instances, the weather activates capable of damaging the roof include hailstorm activities with varying hail stone sizes rated for damaging the particular type of roof. In addition, the artificial intelligence-based instructions of the present application 120 analyzes the series of time-lapse images of the roof before and after the severe weather activities to identify the changes in the roof characteristics associated with the roof. The above information related to the roof, collected using the application 120 launched from the electronic computing device 102, is compared with the present roof conditions set by the insurance service provider to determine the eligibility status of the roof.

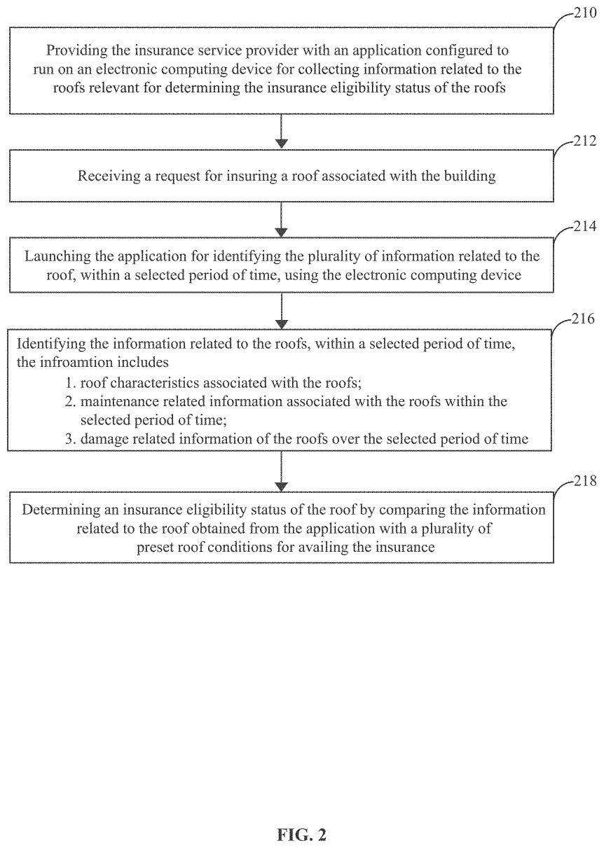

FIG. 2 is a flowchart showing a number of steps of the present computer-assisted method for assisting an insurance services provider to process an insurance request for one or more roofs associated with a building within a geographical area, according to an exemplary embodiment of the disclosed principles. The present method for assisting the insurance services providers to determine the eligibility of the roofs of buildings prior to insuring the roofs includes the first step of providing the application 120 configured to run on the electronic computing device 102 of the insurance service provider for collecting a variety of information related to the roofs, which are relevant for determining the insurance eligibility status of the roofs, as shown in block 210. In a next step 212, the insurance service providers receive a request for insuring the roof of a building. The insurance service provider collects the information related to the roof of the building including an address or location of the building from the person or entity requesting the insurance coverage. Now, the insurance service provider launches the application 120 from the electronic computing device 102 to collect the variety of information related to the roof, which includes the historical information related to the roof over a selected period of time, as in block 214. Now, as in block 216, the insurance service provider receives the relevant information related to the roof required for determining the insurance eligibility status. The information collected by the insurance service provider includes the roof characteristics and other past and present maintenance and damage related information of the roof. The collected past and present maintenance and damage related information of the roof, for the selected duration or time period, is further analyzed by the insurance service provider and compared with the preset roof conditions to determine the insurance eligibility status of the roof, as in block 218. If the roof meets the requirements of the insurance service provider, the insurance coverage of desired value is given to the roof of the building. In some cases, the past or present maintenance and damages on the roof may result in the rejection of the insurance coverage request. In some other instances, the insurance service provider can instruct to perform required maintenance activity on the roof prior to receiving the insurance coverage for the roof.

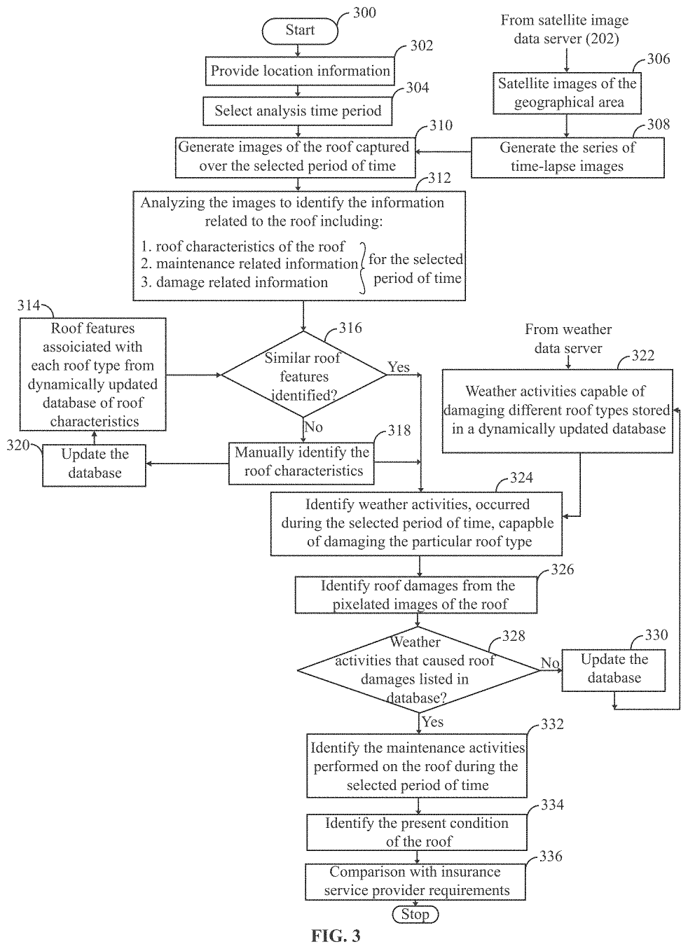

FIG. 3 illustrates another flowchart showing a number of operating steps of the present application 120 for assisting the insurance service provider to process the insurance request for insuring a roof associated with a building, according to an embodiment of the disclosed principles. The present application 120 performs a number of steps as discussed below to assist the insurance service provider to determine the insurance eligibility status of the roof of the building requesting for an insurance coverage. The insurance services provider can launch the application 120 from their electronic computing devices 102 such as a computer, as in step 300. Then as in step 302, the interactive dynamic graphical user interface of the application 120 allows the insurance services provider to provide the location information of the building with the roof, for which the owner submits an insurance request. Further, as in step 304, the interactive dynamic graphical user interface of the application 120 allows the insurance services provider to set desired parameters, such as the desired time period of analysis of the roof, for obtaining the relevant information related to the roof to identify the insurance eligibility status of the roof. The application 120 running on the electronic communication device 102 is further in communication with the satellite image data server 202 or a third party satellite imaging application such as, but not limited to, Google Earth and other regional aerial imaging applications, to receive the satellite images of the geographical area 206 covering the particular roof, as in step 306. The image processing instructions of the application 120 processes the past and present satellite images of the geographical area covering the roof and creates the series of time-lapse images involving the roof, as in step 308. The series of time-lapse images of the roof is further processed and analyzed using the artificial intelligence-based image-processing instructions of the application 120 to identify the information related to the roof relevant for determining the insurance eligibility status of the roof as in steps 310 and 312, respectively. The time-lapse images of the roof is further processed and analyzed using the artificial intelligence-based image-processing instructions of the application 120, processes the assist the insurance service provider to identify the roof characteristics of the roof, and other maintenance and damage related information related to the roof. In some instances, some of the maintenance and damages might have occurred during the selected period of time for the satellite image capture or for the analysis of the roof by the insurance service provider.

Now the roof characteristics of the roof are identified using the artificial intelligence-based instructions of the application 120 by comparing a number of features of the roof identified from the series of time-lapse images of the roof to a number of predefined roof features associated with a number of roof types stored in a dynamically updated database of the application 120, which is shown in steps 314 and 316. In some other instances, the present application 120 allows the insurance service provider to manually identify the roof features of the roof by visual analysis of the series of time-lapse images of the roof capture over the selected period of time, as in step 318. In some instances, the roof characteristics identified from the images of the roof includes a roof type, an age of the roof, at least one roof material, at least one roof dimension, at least one material covering the roof, at least one pre-existing roof damage related information and at least one maintenance information prior to the selected period of time and other related roof information relevant for determining the insurance eligibility status of the roof. The artificial intelligence-based instructions of the application 120 enables the application to self-learn the and improve the accuracy of image analysis and roof features detection by dynamically updating the database associated with the roof characteristics, as in step 320.

The insurance service provider further obtains information related to the damages and the respective maintenance activities performed on the roof by analyzing the series of time-lapse images of the roof. Some of these damages might have been caused by severe weather activities such as wind, heavy rain and other hailstorm activities with hail stone sizes larger than the threshold size for damaging the particular type of roof. The artificial intelligence-based instructions of the present application 120, obtains the weather data of the geographical area covering the roof from a weather data server. In some instances, the weather activities occurred within the geographical area is retrieved from a dynamically updated database associated with the present application 120, as in step 322. The present application analyzes these weather activities and identifies the weather activities occurred within the geographical area, during the selected period of time, capable of damaging the particular roof type, as in step 324. Now, as in step 326, the artificial intelligence-based image-processing instructions of the present application 120 identifies the damages to the roof caused by the above identified weather activities capable of damaging the particular roof type by comparing the sequential changes in a number of pixels in the series of time-lapse images and a number of changes in the roof characteristics identified from the series of time-lapse images of the roof and correlating with the weather activities capable of damaging the roof, occurred during the selected period of time. In some cases, the damages are caused by weather activities, which are not listed as weather activities capable of damaging the particular roof type. Then the present application 120 updates the database of the weather activities capable of damaging the roof types with the available information as in steps 328 to 330. Further, as in step 332, the artificial intelligence-based image-processing instructions of the present application 120 identifies the maintenance related activities performed on the roof after the damages caused by the weather activities, by analyzing the series of time-lapse images of the roof captured prior to and after the weather activity caused the damages to the roof. Finally, the insurance service provider also obtains the present condition of the roof by analyzing the recent images of the roof or the final images among the series of time-lapse images of the roof, as in step 334. This gives the insurance service provider an insight into the present condition of the roof. Now the insurance service provider can compare the information related to the particular roof collected using the present application with the preset insurance eligibility requirements to determine the insurance eligibility status of the roof In some instance, the present application 120 allows the insurance service provider to perform this step, as in 336. In some other instances, the insurance service provider either manually or using a third party application to determine the insurance eligibility status of the roof.

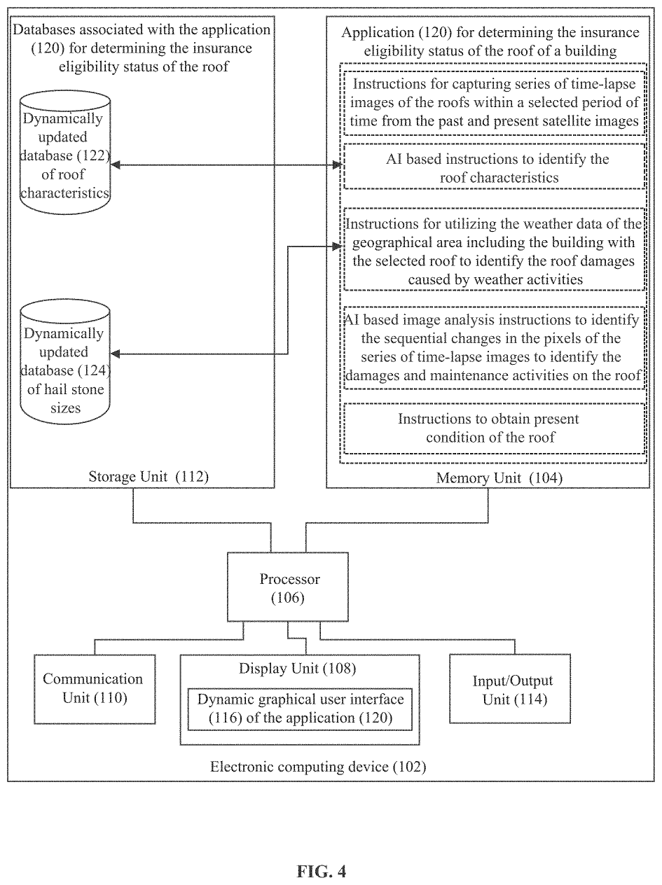

FIG. 4 illustrates a block diagram showing a number of hardware and software components of the electronic computing device 102 configured to run an application for assisting an insurance service provider to process an insurance request for a roof associated with a building within a geographical area, according to an embodiment of the disclosed principles. According to the embodiment, the electronic computing device 102 is a computer having a memory unit 104 to store the instructions of the application 120 for assisting the insurance service provider to process the insurance request for the selected roof and one or more processors 106 to process the instructions of the application 120 to perform a number of tasks such as collecting the information related to the selected roof, relevant for determining the insurance eligibility status of the roof. The electronic computing device 102 further includes a display unit 108 to present the images of the roof, which is available in form of the series of time-lapse images showing the condition of the roof throughout he selected period of time, through an interactive and dynamic graphical user interface 116 of the application 120. The series of time-lapse images of the roof displayed through the display unit 108 assists the insurance service provider to visually identify the roof characteristics, the damages occurred to the roof and the maintenance activities performed on the roof during the selected time period. The electronic computing device 102 also includes a communication unit 110 to enable communication with the external network devices such as the other devices and servers over Internet through wired or wireless communication means to receive the images of the roof of the building. Further, the weather data associated with the particular geographical area is collected from the weather data server 204 over the Internet using the communication unit 110. A storage unit 112 associated with the electronic computing device 102 stores a variety of information associated with the application 120 for identifying the information related to the roof, which is relevant for determining the insurance eligibility status of the roof. In some other embodiments of the disclosed principles, the storage unit 112 stores the instructions of the application 120 for identifying the serviceable roofs in the selected geographical location(s) and the instructions are made available to the memory unit 104 during execution using the processor 106. In yet another embodiments, the storage unit 112 stores predefined roof features of a number of roof types and weather activities capable of damaging the roof types for further utilization by the application 120 during the execution of the instructions of the application 120 using the processor 106. The storage unit 112 stores the type, magnitude and threshold values associated with the weather activities capable of damaging the different roof types, threshold sizes of hail stones during a hailstorm capable of damaging the different roof types and other general information related to the roof characteristics associated with different types of roofs, etc. The electronic computing device 102 also includes an input-output unit 114 to enable the device 102 to connect with peripheral devices such as, but not limited to, printers, keyboards, external display devices and other external electronic devices.

In some other embodiments, the information stored in the storage unit 112, for further utilization by the application 120, of the electronic computing device 102 is dynamically and automatically updated. In some other embodiments, the information stored in the storage unit 112, for further utilization by the application 120, is manually updated based on the visual verification of the images of the roofs obtained in form of the series of time-lapse images from the past and real-time satellite images of the selected geographical area. The visual inspection of the series of time-lapse images reveal a number of information related to each of the roofs such as, but not limited to, the roof material, past maintenance information of the roof, type of roof, age of the roof, past and present condition of the roof etc. In some instances, the users visually analyzing the series of time-lapse images of the roofs are allowed to dynamically update the roof related information stored in the storage unit 112. In some instances, the information related to the roof characteristics is stored in the storage unit 112 in form of a dynamically updated database 122. In addition, the weather data including the information related to the weather activities capable of damaging the different types of roofs are also stored in form of another dynamically updated database 124 within the storage unit 112. The present application 120 further allows the manual updating of both the database 122 and 124 by visually analyzing the images of the roofs presented through the display unit 108 and by analyzing the relevant weather information received through other sources. In yet another embodiments, the instructions of the application 120 stored in the storage unit 112 includes artificial intelligence-based image-processing instructions to perform the automated processing and analysis of the images of the selected roof, which is made available in form of the series of time-lapse images or the roof obtained from the past and present satellite images of the geographical area covering the particular roof. The analysis of the roof images using the artificial intelligence-based image-processing instructions reveals the roof characteristics, damages occurred to the roof, during the selected period of time, by the severe weather activities. The artificial intelligence-based instructions of the application 120 when executed using the processor 106, enables automated updating of the dynamically updated database 122 for storing the identified roof characteristics, according to one or more embodiments of the disclosed principles. One or more features associated a variety of roofs types are stored in the database 122 and are automatically compared with the features of the roofs identified from the images of the roof collected from the series of time-lapse images of the roof. The execution of the artificial intelligence-based image-processing instructions of the present application 120 using the processor 106 thus identifies the roof characteristics of the roof and updates the relevant information into the dynamically updated database 122 storing the roof characteristics of different types of roofs. Similarly the artificial intelligence-based instructions of the present application 120, when executed using the processor 106, enables the automated identification of the weather activities capable of damaging the roof by analyzing the changes to the roof prior to and after the severe weather activities and automatically updates the dynamically updated databases 124 of the weather activities stored in the storage unit 112. Thus, the present application 120 enables the insurance service providers to easily determine the insurance eligibility status of the roof by analyzing the changes to the roofs, such as the changes in the roof characteristics, damages caused to the roof, maintenance activities performed on the roof etc., during the selected period of time.

In some other embodiments of the disclosed principles, the electronic computing device 102, is a portable electronic device such as, but not limited to, a smartphone, tablet, laptop and other portable devices capable of executing the instructions of the application 12, which can be carried by a person associated with the insurance service provider visiting the site for collecting more accurate information related to the roof. In some other embodiments, the electronic computing device 102 is any electronic device capable of launching the application, either installed into the device 102 or through a web interface. In such devices, the application is made available in form of a web application, or a software-as-a-service application, which can be accessed by the insurance service provider from anywhere for determining the insurance eligibility status of the roofs. In all such instances, the application 120 running on the electronic computing devices 102 enables automated capturing of the images of the roof in form of the series of time-lapse images obtained from the past and present satellite images of the geographical area and performs automated identification of the information related to the roof relevant for determining the insurance eligibility status of the roof.

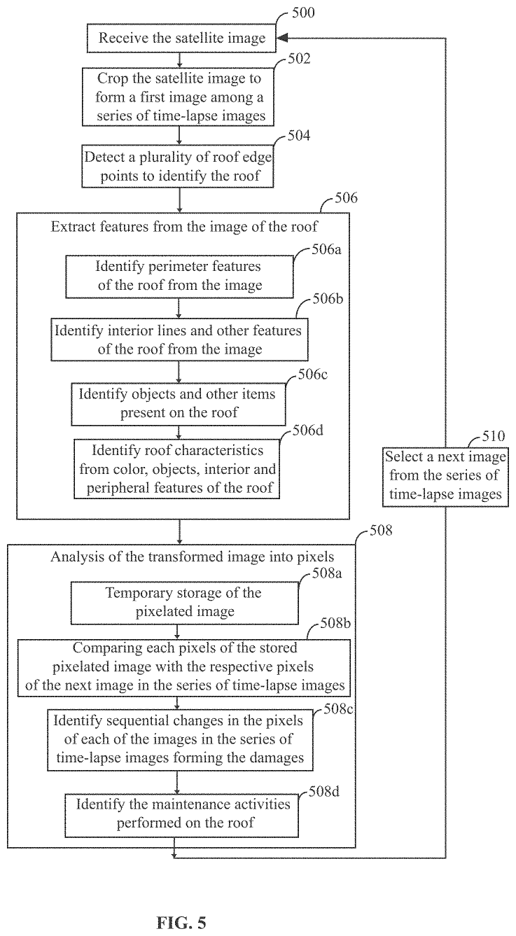

The present application 120 for assisting the insurance service providers to determine the insurance eligibility status of a roof performs the image processing and automated analysis of the series of time-lapse images of the roof, captured over a particular period of time, to collect the information related to the past and present conditions of the roof relevant for determining the eligibility status of the roof. FIG. 5 is an exemplarary flowchart showing the image processing, image conversion and analysis steps of the series of time-lapse images of the roof, captured over the selected period of time, to collect the information related to the past and present conditions of the roof including the past and present damages and maintenance related information relevant for determining the insurance eligibility status of the roof, according to an embodiment of the disclosed principles. The steps for identifying the information related to the past and present conditions of the roof including the past and present damages and maintenance related information relevant for determining the eligibility status of the roof starts with the step of receiving the satellite images of the geographical area covering the selected roof, as in step 500. Prior to collecting the satellite images, the application 120 allows the insurance service provider to select a desired duration or period of time for collecting the satellite images of the roof. In some instances, the insurance service provider is allowed to select a few years prior to the present date for analyzing the past and present information related to the particular roof such as the damages and maintenance related information on the roof. The satellite images of the geographical area are processed using the present application 120 to create the series of time-lapse images of the roof over the selected period of time, as in step 502. In step 504, the image processing instructions of the application 120 perform a variety of image processing steps to identify the edges of the roof using an edge detection algorithm or similar edge detection methods commonly employed in one or more types of image processing applications. Once the roof, which is under request for obtaining the insurance coverage from the insurance service provider, is identified from the image, the application 120 performs a variety of image processing steps using the artificial intelligence-based instructions of the application to identify the roof characteristics, as in step 506. The application 120 further identifies the roof features of the roof in a number of steps from 506a to 506d. In some instances, the step for identifying the roof features or the roof characteristics may include the step of identifying the perimeter features of the roof from the image as in step 506a, then identifying the interior lines and other interior features of the roof within the perimeter as in step 506b, followed by identification of the objects such as HVAC coils present in the roof as in step 506c and using the above information along with the color and other identified features of the roof from the image to define the roof characteristics of each of the roof as in step 506d. In this stage, the present application 120 makes use of the stored roof features of a variety of roof types from the roof characteristics database 122 associated with the present application 120 for proper identification of the roof type and other features of the roof. The insurance service providers can utilize the above-identified information related to the roof for determining the past and present conditions of the roof.

The present application 120 further processes the image of the roof to identify the information related to the roof such as the maintenance related information and the damage related information of the roof over the selected period of time. The image of the roof is also processed to identify the present condition of the roof. The insurance service provider further processes the above-identified information to determine the insurance eligibility status of the roof by comparing the relevant information related to the roof obtained from the application 120 with a number of preset roof conditions for getting the insurance coverage. In order to detect the damages on the roof, which may be caused by the severe weather activities occurred on the particular geographical area, the image is transformed into a corresponding pixelated image, as in step 508. In order to identify whether any of the severe weather activities caused damages to the roof, the application 120 communicates with the weather data server 204 and the stored weather activity related information capable of damaging the particular type of roof and correlates the information thus obtained with the sequential changes in the corresponding pixels of the time-lapse images of the roof prior to and after the severe weather activity. For the above process, as in step 508a, the pixelated image is stored in a temporary storage for further comparison in step 508b, in which each pixel of the subsequent images in the series of time-lapse images are compared to identify the sequential changes in the pixels of each image as in step 508c. The application 120 identifies the damages on the roof by comparing the sequential changes, which are happened prior to and after the sever weather activities, in the pixels of each image in the series of time-lapse images of the roof obtained from the satellite images captured within the selected period of time. For example, if a same black spot(s) present in any of the image of the roof among the series of time-lapse images with the addition of other black spots in the nearby pixels in the sequential images, then the sequential changes in the pixels of the series of time-lapse images of the roof indicates that the same roof exists and has not been replaced and the black spots are growing or being added over time, with the increase in the age of the roof. In some other instances, the spots in any of the pixels of any of the images of the roof, caused by damages to the roof, is not present in the pixels of the subsequent time-lapse images of the roof, which indicates that certain maintenance activity has been performed on the roof, as in step 508d. The type of maintenance activity, the material used, the extent of replacement or maintenance of the roof part etc., can be analyzed from the subsequent images of the roof. The above process is repeated until all the images in the series of time-lapse images of the roof, captured within the selected period of time by the insurance service provider, are processed to identify the roof characteristics, damages to the roof, the maintenance activities performed on the roof and other past and present characteristics of the roof, as in step 510.

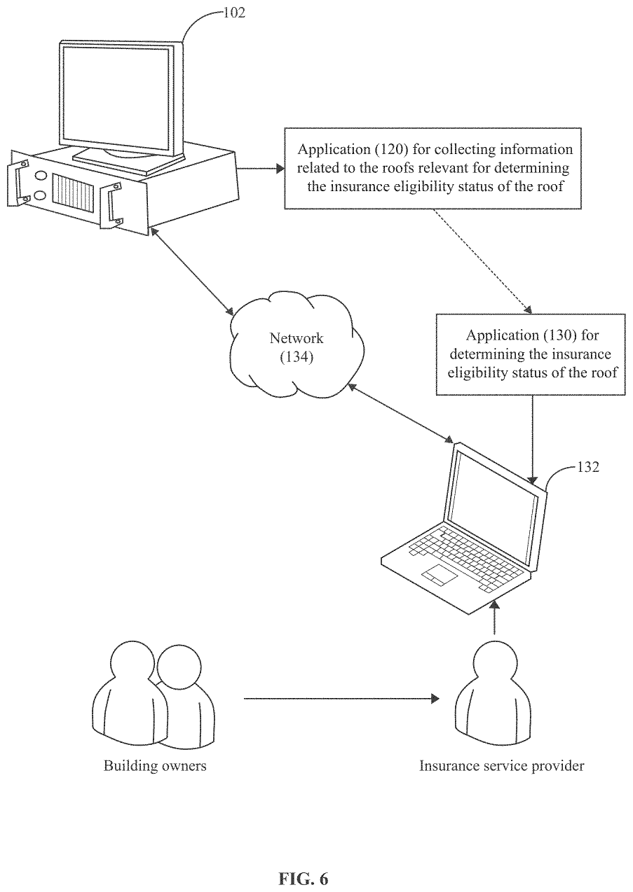

In some instances, the insurance service provider may utilize a third party application 130 for determining the insurance eligibility status of the roof a building. Such an instance is shown in the schematic diagram in FIG. 6, in which the third party application 130 directly communicates with the present application 120 for determining the roof features such as past and present condition, damages and maintenance status of the roof, etc., relevant for determining the insurance eligibility of the roof. The third party application 130 running on a computer 132 associated with the insurance service provider directly communicates with the present application 120 running on a remote computer 102 via a wireless or wired network 134 and automatically collects the above said information. The information related to the roof, such as the past and present condition, damages and maintenance status of the roof, etc., are automatically processed and compared with the preset roof conditions in the third party application 130 to instantly determine the insurance eligibility status of the roof.

The image processing algorithm or the image processing steps of the present application 120, for identifying the information related to the roof that are relevant for determining the insurance eligibility status of the roof includes a number of image preprocessing, processing, image conversion and analysis steps disclosed in many image processing prior art applications listed as below. The image processing instructions of the present application 120 may employ some or most of the image processing steps or a combination of the image processing steps from one or more image processing applications from some prior arts listed below, according to one or more embodiments of the disclosed principles. The image processing instructions of the present application 120 may employ a variety of image processing techniques, some of which are disclosed below with the help of similar image processing techniques employed by several image processing prior art patent teachings. One such image processing technique employed in U.S. Pat. No. 7,711,157 titled “Artificial Intelligence Systems For Identifying Objects”. The process for object identification, according to the prior art, comprising extracting object shape features and object color features from digital images of an initial object and storing the extracted object shape features and object color features in a database where said extracted object shape features and object color features are associated with a unique identifier associated with said object and repeating the first step for a plurality of different objects. Then extracting object shape features and object color features from a digital image of an object whose identity is being sought and correlating the extracted object shape features and object color features of the object whose identity is being sought with the extracted object shape features and object color features previously stored in the database. If a first correlation of the extracted object shape features is better than a first threshold value for a given object associated with an identifier in the database and if a second correlation of the extracted object color features is better than a second threshold value for the given object, then making a determination that the object whose identity is being sought is said given object. In an embodiment, one or more steps of the above object identification utilizing object color, texture and shape features can be employed in the present application 120 for identifying the roof characteristics of the roofs and to identify one or more objects present on the roofs.

Another prior art utilizing artificial intelligence-based image-processing techniques, which can be incorporated into the image processing steps of the disclosed principles, is the U.S. Pat. No. 9,679,227 titled “System And Method For Detecting Features In Aerial Images Using Disparity Mapping And Segmentation Techniques”. The disclosed prior art system for aerial image detection and classification includes an aerial image database storing one or more aerial images electronically received from one or more image providers, and an object detection pre-processing engine in electronic communication with the aerial image database, the object detection pre-processing engine detecting and classifying objects using a disparity mapping generation sub-process to automatically process the one or more aerial images to generate a disparity map providing elevation information, a segmentation sub-process to automatically apply a pre-defined elevation threshold to the disparity map, the pre-defined elevation threshold adjustable by a user, and a classification sub-process to automatically detect and classify objects in the one or more stereoscopic pairs of aerial images by applying one or more automated detectors based on classification parameters and the pre-defined elevation threshold. One or more image analysis steps of the above prior art can be utilized by the present artificial intelligence-based image processing instructions of the present application 120 to identify the roof features from the images captured from the past and present satellite images.

Another prior art disclosing the image processing steps to identify the features from the images is disclosed in U.S. Pat. No. 5,625,710. The prior art recognizes the features such as the character from an image using pixelated form of the images to compare with a reference image to identify the changes in the pixels of the image from the reference image to identify the characters. A similar processing step can be used by the artificial intelligence-based image processing instructions of the present application 120 to identify the damages to the roofs by comparing with a previous image of the roof, before the damages, from the series of time-lapse images.

In one or more embodiments of the disclosed principles, the image processing technique(s) performed by the processor 106 of the electronic computing device 102, by executing the image processing instructions or the artificial intelligence-based instructions of the application 120, enables any suitable image detection, feature detection/extraction, pattern detection, edge detection, corner detection, blob detection, ridge detection, color detection, and/or any other image processing technique(s) to determine the roof characteristics, and other damages and maintenance related information of the roof relevant for determining the insurance eligibility status of the roof present in the series of time-lapse images obtained from the past and present satellite images of the selected geographical area. In some instances, the image processing instructions of the present application, when executed using the processor 106, performs a series of image processing steps, which are commonly employed to identify features from the digital image, such as, but not limited to, SIFT (Scale-Invariant Feature Transform) technique, a SURF (Speeded Up Robust Features) technique, and/or a Hough transform technique, etc., to detect the roof characteristics of each of the roofs present in the images available in form of the series of time-lapse images obtained from the past and present satellite images of the selected geographical area.

In some other embodiments of the disclosed principles, the image processing instructions of the present application 120, when executed using the processor 106 of the electronic computing device 102, enables identification of one or more features of the roof and compares the identified features with the predefined or previously stored features or the roof characteristics in the dynamically updated database 122 in real-time. In some other embodiments, the image processing instructions of the application 120 include a number of artificial intelligence-based instructions configured to identify the roof characteristics, such as but not limited to, roofing material, roofing type, age of the roof, etc., by generating a matching score when comparing with the previously stored features or the roof characteristics in the dynamically updated database 122 in real-time. In yet another embodiments, the present application 120 for assisting the insurance service providers to determine the insurance eligibility status of the roof may incorporate a image processing and roof characteristics identification module that performs the image processing to determine which of the products or features of the roofs in the database 122 are associated with roof characteristics that “match,” or are sufficiently “similar” to, the roof characteristics of the roof determined by the present application 120. The processing steps for determining whether a particular roof characteristics in the database 122 “matches” the roof characteristic of the roofing materials present in the images may vary according to different embodiments. In some other instances, the dynamically updated database 122 storing the roofing characteristics of a variety of types of roofs may assist the application 120 to identify the roof features or the roofing characteristics of the roof in the images, requesting insurance protection, using one or more roofing part manufacturer characteristics, such as, but not limited to, tab or tile length, recommended installation pattern, recommended exposure width, etc., associated with the roofing product. In some other instances, the dynamically updated database 122 associated with the present application may include a single database or additionally include one or more third party databases such as the respective roofing material product manufacturers. Thus, the artificial intelligence-based image-processing instructions of the present application combines one or more features of the prior art image processing steps and other novel image comparison and identification steps employed in the disclosed principles to identify the past and present status of the roof relevant for determining its insurance eligibility status.

In one or more embodiments of the disclosed principles, the roof features such as the past and present roof characteristics, damages and maintenance related information of the roof, requesting for insurance coverage, are identified by processing the series of images of the roof and correlating with other severe weather activities, occurred within the selected period of time, capable of damaging the roof. In a certain embodiment of the disclosed principles, the weather data of the selected geographical area covering the roof, requesting for the insurance coverage, is collected from a weather data service provider such as, but not limited to, national weather data service provider. In such an instance, the present application 120 communicates with the national weather data service provider server 204 to collect the weather data within the selected period of time. In an exemplarary embodiment, the present application 120 communicates with the national oceanic and atmospheric administration servers 204 for obtaining the weather data and the received weather data map of the area within the selected period of time is overlaid on the past and present satellite images, such as, but not limited to Google Earth images, of the selected geographical area, captured within the same period of time. This allows the present application 120 to analyze the combined images of the weather activities and the series of the time-lapse images of the roof to identify the causes of the damages on the roof. This also enables the insurance service provider to verify the roof prior to and after the severe weather activity for identifying any visible damages to the roof.

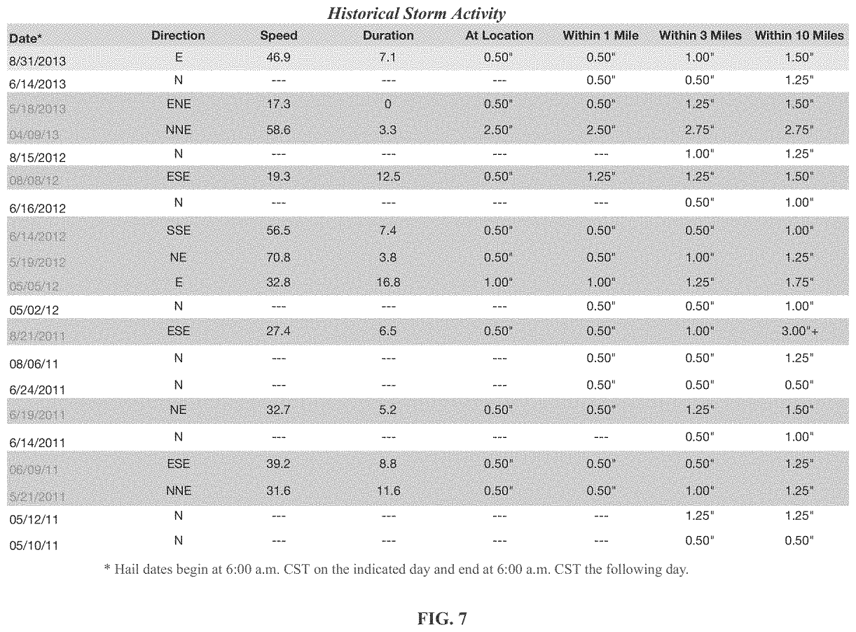

In some other instances, the weather data of any selected geographical area is collected from multiple weather data service provider servers 204 such as, but not limited to, www.interactivehailmaps.com, national oceanic and atmospheric administration and other weather data service providers. These weather data maps may include the detailed map of the hailstorm activities over the selected geographical area(s), which are analyzed by the present application in real-time to identify the damages on the roof, requesting for an insurance coverage that might have caused by the weather activity. FIG. 7 is a chart showing the details of the hailstorm activities over a particular area and the hail stone sizes fell during the particular hailstorm activity, according to an exemplarary embodiment of the disclosed principles. Certain weather data service providers such as the www.interactivehailmaps.com site allows the insurance services providers to select a particular geographical area, or certain address of a building within the geographical area to retrieve the past and present hailstorm activities details, within the selected time period, of the particular region and the results are presented to the application 120 for further processing to identify the damages to the roof, which might have caused by the hailstorm activities. The hailstorm chart thus obtained from the weather data service provider servers 204 provide the dates of occurrences of the hailstorm activities at a certain building address or a selected geographical area. The weather data service provider servers 204 also provide the sizes of the hailstones, which include small hail stones that does minimal damage to the roofs, and larger hailstones of sizes 3.8 cm, which is the minimum threshold for damage to commercial roofing materials and above capable of damaging the roof materials and other A/C coils of rooftop HVAC accessories, during each of the hailstorm activities. The dates of each of the hailstorm activities can be directly obtained from the chart shown in FIG. 7, which can further be utilized to analyze the changes to the roof, requesting for the insurance coverage, in the particular geographical area prior to after the particular hailstorm activity. In some instance, the selected weather data is correlated with the roof type or the roof characteristics of the roof, requesting for the insurance coverage, to identify the one or more damages caused by the severe weather activities. In some instances, the artificial intelligence-based image-processing instructions of the application 120 processes the series of time-lapse images of the roof to identify the changes in the series of time-lapse images to identify the damages on the roof. The damages on the roof is also identified by comparing a number of sequential changes in one or more pixels of the series of pixelated time-lapse images, one or more changes in the roof characteristics identified from the series of time-lapse images and correlating the information thus collected with the weather activities capable of damaging the particular roof type during the selected time period. This in turn helps the insurance service provider to identify the damages caused on the roof, date of damage and the causes, the extent of the damage caused by the weather activity, following maintenance activity on the roof etc., relevant for determining the insurance eligibility status of the roof.

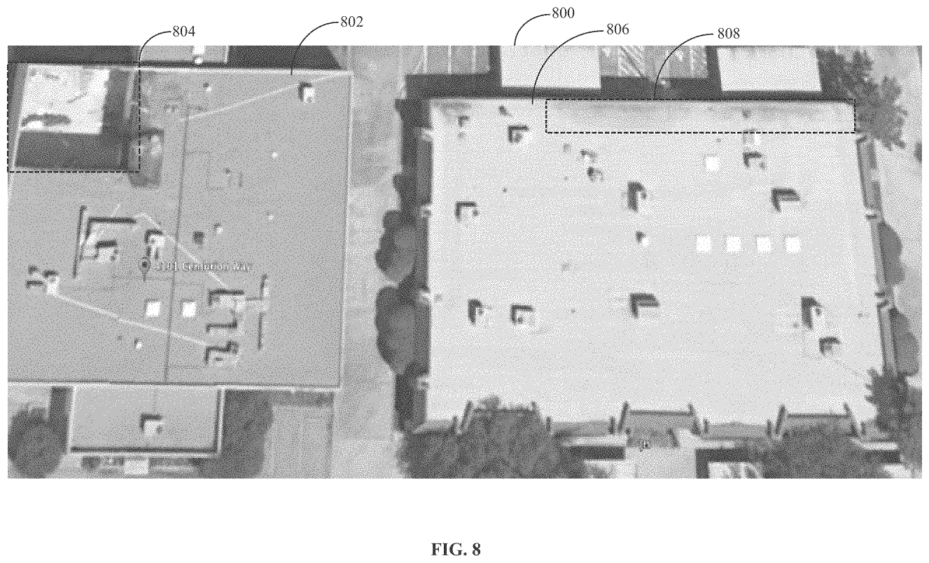

In some instances, the present system 100 and method can be utilized by the insurance service provider to determine the insurance eligibility status of multiple roofs belonging to a single building complex as discussed below. FIG. 8 is an exemplarary image 800 of a pair of roofs obtained from the series of time-lapse images captured from the past and present satellite images of the selected building facility within the selected geographical area, according to an exemplarary embodiment of the disclosed principles. The application 120 identifies the type of roof 802 on the left side of the image 800, which is captured on a date 1 Mar. 2011, as a ‘gravel ballasted built up roof’ from a brown color of the roof 802 and due to the lack of dark spots on the roof 802. The dark spots in the images of the roofs generally represent the presence of dirt and algae that has been left over from ponding water. The lack of dark spots on the roof 802 on the left side of the image 800 denotes the absence of dirt and algae that has been left over from ponding water commonly seen on other roof types. Further, the artificial intelligence-based image processing instructions of the present application 120 is capable of differentiating the type of the roof 802 from other types of roofs such as, but not limited to, a tan colored torch down roof with the lack of seams, made by rolls of roof material forming regular, repeating seams at the joints. In some other instances, the present application 120 detects the type of roof by identifying the seams of the material covering the roof and categorizing the material based on the width of the seams. Further, the artificial intelligence-based image processing instructions of the present application 120 detects a missing section or damage 804 at a top left corner of the roof 802, which is of different color compared to the other parts of the roof 802. The artificial intelligence-based instructions of the present application 120 identifies the missing section or damage 804 at a top left corner of the roof 802 by analyzing the image 800 captured on the above said date 1 Mar. 2011 with a series of time-lapse images of the roof 802 captured prior to and after the above mentioned date. The present application 120 also looks into the weather activities happened prior to the above said date and analyzes the series of time-lapse images captured prior to and after the above mentioned date to identify the type of weather activity, such as, but not limited to a storm event or similar weather activities, responsible for the fault. The monitoring of the image 800 from the series of time-lapse image captured on a later date reveals the maintenance activities performed on the roof 802 to cover the damage 804. If no such maintenance activity is performed on the roof 802 and the damage 804 is still visible on an image captured on a later date, the insurance service provider can either advise the owner of the building to perform the necessary maintenance activities on the roof 802 or can deny the request for the insurance coverage.

Similar to the above analysis of the roof 802 on the left side of the image 800, the present application analyzes the roof 806 on the right side of the image 800 to identify the roof characteristics, such as the presence of dark stains along the rear edge 808 of the roof 806, which may be caused by the collection of algae and dirt near the drains. The continuous monitoring of the dark stains along the rear edge 808 of the roof 806 from the series of time-lapse images of the roof 806 helps to identify the maintenance status, replacement or roofing material and the other relevant information of the roof 806. The present application 120 allows the automated analysis and manual inspection of the selected roofs present in the series of time-lapse images obtained from the past and present satellite images of the selected geographical area. This in turn improves the accuracy of the present application 120 in detecting the roof characteristics and damages on the roofs. The automated inspection of the series of time-lapse images of the roofs is performed in a number of methods as discussed earlier. However, an exemplary embodiment of the present application 120 employs one or more image pixilation steps to identify the sequential changes in each pixel of the series of time-lapse images of the roofs for accurate identification of the roof characteristics and damages on the roofs. One such exemplarary method for detecting the roof characteristics and damages on the roofs is discussed using the flowchart in FIG. 5.

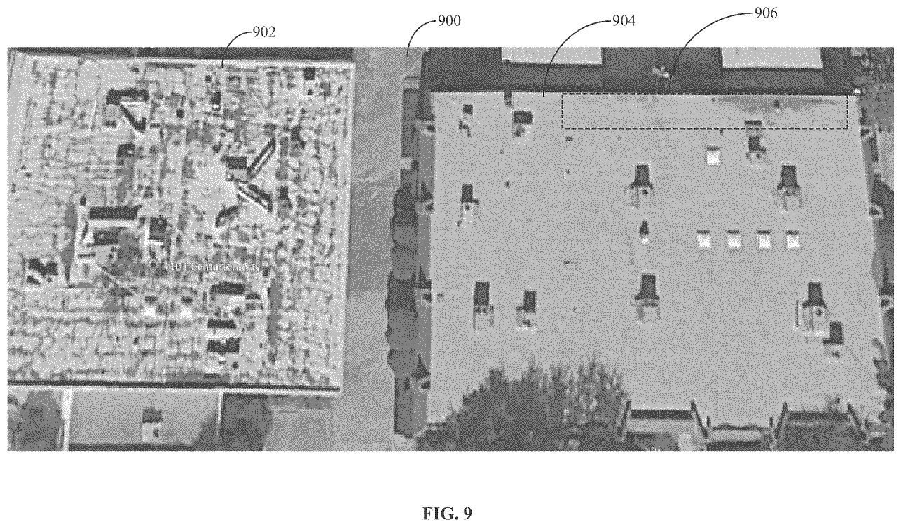

FIG. 9 is an exemplarary image 900 of the pair of roofs, shown in the image 800, obtained from the series of time-lapse images captured from the present satellite images of the selected geographical area, according to an exemplarary embodiment of the disclosed principles. The images of the roofs 902 and 904 in the image 900 are obtained from the satellite image of the geographical area captured on 1 Jul. 2017, after 6 years from the data of capture of the image 800 in FIG. 8. From the visual analysis of the image 900 and image 800 in FIG. 5, it is clear that the damage 804, i.e., the top left hand square marked as 804 in FIG. 5, is repaired. Furthermore, the color and texture of the roof 902 in image 900 is changed from the corresponding roof 802 present in the image 800. This indicates the maintenance activity on the roof 802 within the six years period. In addition, the material of the roof 902 is changed from ‘gravel ballasted built up roof’ to ‘spray foam/elastomeric coated roof’. The material change on the roof 902 is identified by analyzing each pixel of the pixilated images of image 900 showing dark and light colors compared to the and corresponding pixels of the roof 802 in the image 800. Moreover the damaged part 804 present in the roof 802 in the image 800 is also missing, pointing to a maintenance activity.

The roof 904 on the right shows little growth to the dark stains along the rear edge 906, during the selected period of time, when compared with the dark stains along the rear edge 808 of the roof 806 in FIG. 5. This shows that the roof 904 must have been repaired recently with the same material. The above information is stored in the roof characterizes of the particular roof and is later utilized by the insurance service provider to determine the insurance eligibility status of the roof 904. In some instances, the present application 120 identifies the severe weather conditions around a particular date and analyzes the images of the selected roof captured prior to and after the severe weather activities to identify the damages on those roofs caused by the weather activities such as hailstorm activity with hail stone sizes higher that a preset threshold value for the particular roof type. Table 1 and Table 2 show an exemplary threshold hailstone sizes chart for different roof types, which are utilized during the analysis of the images prior to and after the hailstorm events to easily identify the roofs with high probability of getting damaged, along with the other roof characteristics of the roofs identified from the images of the roofs.

TABLE 1
Hail threshold for low slope roof coverings

| Roof Type | Threshold Value (inches) |
|---|---|
| Built-up roofing - smooth | 1 1/2 to 2 |
| Built-up roofing - aggregate surfaced | 2½ |
| Polymer modified bitumen membrane | 1 1/2 to 2 |
| Thermoplastic single ply membrane | 1 to 2 |
| EPDM | 2 |
| EPDM-ballasted | 2½ |
| Spray polyurethane foam | ¾ |
| Steel panels | 2½ |

The below table, Table 2, shows experimental results of the threshold hail sizes for causing damages to the different roof types.

TABLE 2
Hail stone impact test results for various roof type

| | | Hailstone | Hailstone | Hailstone | Hailstone | Hailstone |
|---|---|---|---|---|---|---|
| Type of roofing | Age | 25 mm | 32 mm | 38 mm | 44 mm | 50 mm |
| 3-tab fiber glass | 11 | 0 | 60 | 90 | 100 | 100 |
| shingles | | | | | | |
| 3-tab organic shingles | 11 | 50 | 90 | 100 | 100 | 100 |
| 30-year laminated | 11 | 0 | 0 | 60 | 90 | 100 |
| shingles | | | | | | |
| Cedar Shingles | 11 | 0 | 30 | 80 | 100 | 100 |
| Heavy Cedar shakes | 0 | 0 | 0 | 50 | 90 | 100 |
| Fiber cement tiles | 0 | 0 | 20 | 80 | 100 | 100 |
| Flat concrete tiles | 0 | 0 | 20 | 50 | 50 | 100 |
| S-shaped concrete | 0 | 0 | 0 | 0 | 0 | 80 |
| tiles | | | | | | |
| Built-up gravel | 8 | 0 | 0 | 0 | 0 | 30 |
| roofing | | | | | | |
| No. of products | | 1/9 | 5/9 | 7/9 | 7/9 | 9/9 |
| damaged | | | | | | |

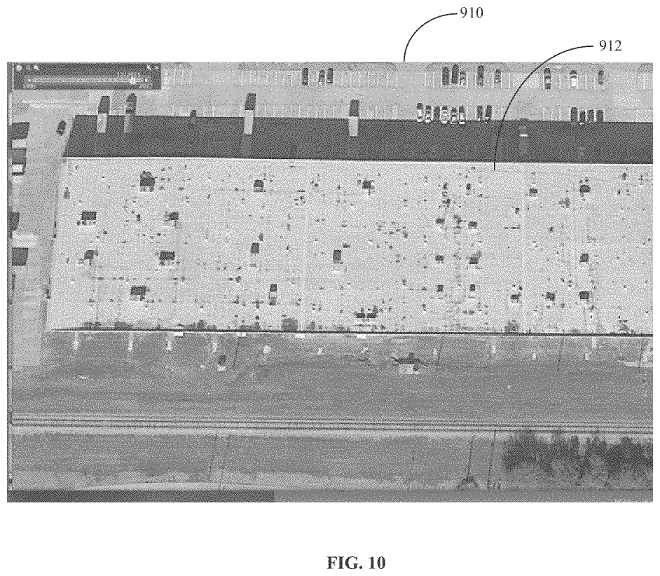

FIG. 10 to FIG. 12 shows exemplarary images 910 of another roof 912, requesting for insurance coverage with the insurance service provider, obtained from satellite images of the selected geographical area taken over a period of time from a first date 1 Dec. 2015 to a current date 1 Apr. 2018, according to an exemplarary embodiment of the disclosed principles. From FIG. 10, the roof 912 in the image 910 is made up of material such as spray foam with an elastomeric coating with no signs of any damages present on the roof 912. The present application 120 captures and processes the series of time-lapse images of the roof between the period from 1 Dec. 2015 to the current date 1 Apr. 2018 to identify the changes in the roof characteristics, including roof type, material, maintenance performed on the roof during this period, damages caused by the weather activities during this period etc.

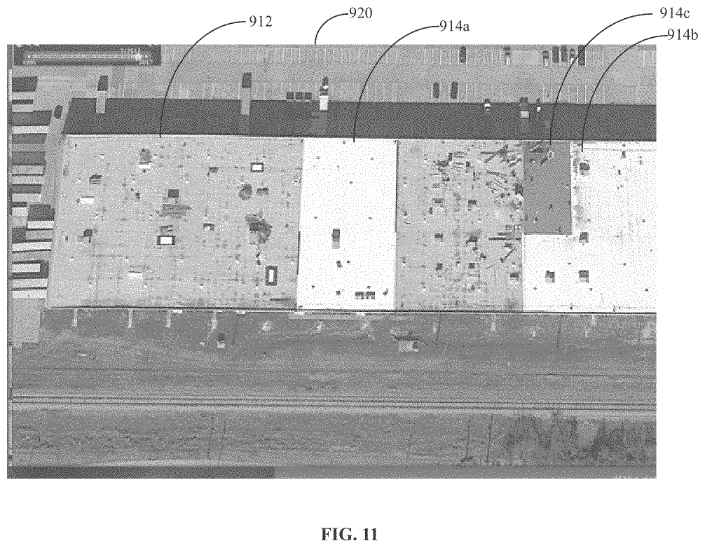

FIG. 11 is an image 920 of the roof 912, requesting for insurance coverage with the insurance service provider, obtained from the satellite images of the selected geographical area taken on the date 1 Sep. 2017, i.e. within the period from 1 Dec. 2015 to the current date 1 Apr. 2018, according to an exemplarary embodiment of the disclosed principles. From the analysis of FIG. 11, either visually or using the artificial intelligence-based image processing instructions of the application 120, it is clear that certain sections such as 914a to 914c of the roof 912 is modified using different materials. The present application 120 further identifies the causes of the damages or condition of the roof 912 that led to the maintenance at sections 914a, 914b and 914c of the roof 912 by correlating the images captured within the above time period with the weather activities that happened in the same time period covering the particular geographical area. The present application analyzes the series of time-lapse images of the roof 912 captured within the above said time period and process the images to create the corresponding pixelated images. The artificial intelligence-based image processing instructions of the application 120 analyzes and compares the sequential changes in each of the pixels in the series of time-lapse images of the roof 912 and correlates with the weather information collected over the period of time to identify the damages caused on the roof 912 during this period. In a certain instance, a hailstorm activity with hail stone sizes larger than the threshold value capable of damaging the particular roof type may have fallen on the roof 912, within the above said time period, which led to the damages of the roof 912 at sections 914a, 914b and 914c of the roof 912. Furthermore, the artificial intelligence-based image processing instructions of the application 120 identifies the roofing material covering the sections 914a, 914b and 914c of the roof 912, which are different from the original roofing material of the roof 912. In some instances, the sections 914a and 914b are covered using spray polyurethane foam or thermoplastic polyolefin (TPO) sheet products and the section 914b is covered using material such as fiber cement tiles. In addition, the artificial intelligence-based image processing instructions of the application 120 identifies that the maintenance on the section 914b is performed on an earlier date than the section 914a. This is identified by the presence of dark spots on the roof section 914b, which is caused by the deposition of dirt and algae over time. The roof material at the section 914a is almost white, which lets the artificial intelligence-based image processing instructions of the application 120 to interpret a more recent maintenance activity on that part of the roof 912.

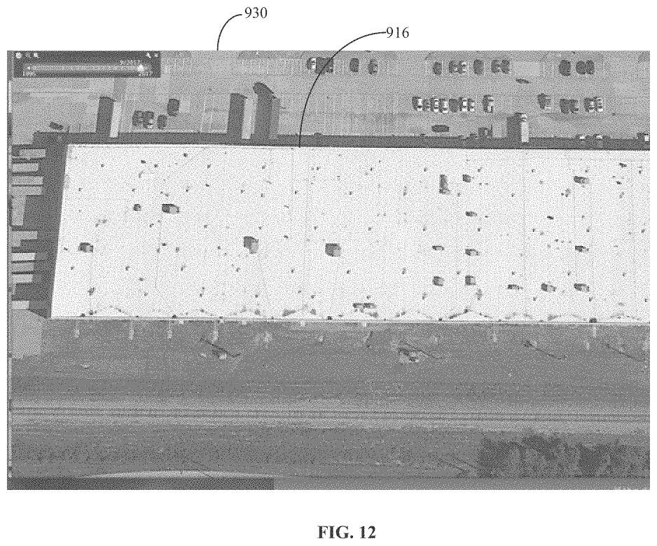

FIG. 12 is an image 930 of the roof 916, requesting for insurance coverage with the insurance service provider, obtained from the satellite images of the selected geographical area taken on the current date 1 Apr. 2018, according to an exemplarary embodiment of the disclosed principles. The analysis of the image 930 of the roof 916 points to the recent maintenance activity on the whole roof 916 with a single type of roof material. The present application 120 can analyze the series of time-lapse images of the roof 916 captured up to the above said date, i.e. within the selected time period from 1 Sep. 2017 to the current date 1 Apr. 2018, and process the images to create the corresponding pixelated images. The artificial intelligence-based image processing instructions of the application 120 analyzes and compares the sequential changes in each of the pixels in the series of time-lapse images of the roof 912 and correlates with the weather information collected over the above period of time to identify the damages caused on the roof 912 during this period. The analysis of the images of the roof 912 to 916, captured over the selected period of time, might have shown the presence of damages throughout the roof 912 caused by a weather activity such as a hailstorm activity with ice size greater than the threshold value for the roof materials covering the whole roof 912. This might have led to the complete replacement or maintenance of the roofing material, as evident from the image 930. The roof 916 in the image 930 is covered with sheets of material such as, but not limited to, the spray polyurethane foam or TPO sheet products or other product that causes seams at the joints, which are visible on the roof 916 in the image 930.

Thus, the artificial intelligence-based instructions of the application 120 analyzes the series of time-lapse images of the roof, requesting for insurance coverage with the insurance service provider, continuously learns from each cycle of processing the images of the roof for providing more accurate results to insurance service provider to determine the insurance eligibility status of the roof. In some other instances, the artificial intelligence-based instructions of the application 120 preforms automated and continuous analysis of the roofs of a particular geographical area to identify the roof characteristics including damages and maintenance activities on the roofs and stores the information in a database for easy accessibility whenever desired. The database is updated regularly and the insurance service providers can obtain the relevant information related to the roof requesting of insurance coverage directly from the database. This also allows the insurance service providers to advise the owners of the building to perform the relevant maintenance activity on the roof prior to the allowance of the insurance coverage. The present system 100 and associated application 120 assists the insurance service provider for proper analysis of past and present condition of each of the roof prior to the allowance of insurance coverage protection.

Further, it should be noted that the steps described in the method of use could be carried out in many different orders according to user preference. The use of “step of” should not be interpreted as “step for”, in the claims herein and is not intended to invoke the provisions of 35 U.S.C. § 112, (6). Upon reading this specification, it should be appreciated that, under appropriate circumstances, considering such issues as design preference, user preferences, marketing preferences, cost, technological advances, etc., other methods of use arrangements, elimination or addition of certain steps, including or excluding certain maintenance steps, etc., may be sufficient.

The foregoing description of the exemplary embodiments of the disclosed principles have been presented for the purpose of illustration and description. While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. A computer assisted method for assisting a plurality of insurance service providers to process an insurance request for at least one roof associated with a building within a geographical area comprising:
a) receiving a request for insuring the roof associated with the building;
b) launching an application for identifying a plurality of information related to the plurality of roofs in the geographical area within a selected period of time using an electronic computing device;
c) utilizing the application to analyze a plurality of images of the roofs obtained from a series of time-lapse images of a plurality of past and real-time satellite images of the geographical area, the series of time-lapse images being captured over the selected period of time for providing the plurality of information related to the roofs including:
a plurality of roof characteristics associated with the roofs;
a plurality of maintenance related information associated with the roofs within the selected period of time;
a plurality of past and present damage related information of the roofs over the selected period of time; and
d) determining an insurance eligibility status of the roof by comparing the plurality of information related to the roof obtained from the application with a plurality of preset roof conditions.

2. The computer assisted method of claim 1, wherein the plurality of roof characteristics is identified by comparing a plurality of features identified from the series of time-lapse images of the roofs to a plurality of predefined roof features associated with a plurality of roof types stored in a dynamically updated database of the application based on a plurality of artificial intelligence-based instructions of the application.

3. The computer assisted method of claim 1, wherein the plurality of roof characteristics identified from the plurality of images of the roof includes a roof type, an age of the roof, at least one roof material, at least one roof dimension, at least one material covering the roof, at least one pre-existing roof damage related information and at least one maintenance information prior to the selected period of time and other related roof information relevant for determining the insurance eligibility status of the roof.

4. The computer assisted method of claim 1, wherein the plurality of maintenance related information and the plurality of past and present damage related information associated with the roof is identified using the plurality of artificial intelligence-based instructions of the application by comparing a plurality of sequential changes in a plurality of pixels in the series of time-lapse images and a plurality changes in the roof characteristics identified from the series of time-lapse images of the roof and correlating with a plurality of weather activities capable of damaging the roof during the selected period of time,
wherein the plurality of maintenance related information and the plurality of past and present damage related information associated with the roof within the selected period of time is analyzed for determining the insurance eligibility status of the roof.

5. The computer assisted method of claim 4, wherein the application allows an automated and a manual identification of the plurality of information related to the roof from the plurality of images captured prior to and after the plurality of weather activities for identifying the insurance eligibility status of the roof,
wherein the weather activities include the hailstorm activities involving a plurality of hailstone sizes, heavy rain, wind, storm, lightning and other weather related activities capable of damaging the roof of the building.

6. The computer assisted method of claim 1, wherein the insurance eligibility status of the roof is identified by a manual visual inspection and/or an automated comparison of the plurality of information related to the roof obtained from the application with the plurality of preset roof conditions using the plurality of artificial intelligence-based instructions of the application.

7. The computer assisted method of claim 6, wherein comparison of the plurality of information related to the roof obtained from the application with the plurality of preset roof conditions enables the insurance service provider to suggest a plurality of maintenance actions to the roof for getting a roof insurance coverage.

8. The system of claim 1, wherein the images are generated using multispectral imaging technology selected from the group consisting of infrared, ultra-violet and thermal imaging.

9. A computer implemented system for assisting a plurality of insurance service providers to process an insurance request for at least one roof associated with a building within a geographical area comprising:
a) an electronic computing device having a memory unit to store a plurality of instructions of an application for identifying a plurality of information related to the roof in the geographical area, within a selected period of time, and
b) a processor configured to execute the plurality of instructions of the application to perform a plurality of tasks including:
1) obtaining a plurality of images of the roof in the geographical area, wherein the plurality of images of the roof being a series of time-lapse images of the roof, obtained from a plurality of past and real-time satellite images of the geographical area, captured over the selected period of time;
2) obtaining a plurality of weather data during the selected period of time from at least one weather data service provider;
3) processing the plurality of images of the roof using a plurality of artificial intelligence-based instructions of the application to identify the plurality of information related to the roof including:
i) a plurality of roof characteristics associated with the roof;
ii) a plurality of maintenance related information associated with the roof within the selected period of time; and
iii) a plurality of past and present damage related information of the roof over the selected period of time; and
4) determining an insurance eligibility status of the roof by comparing the plurality of information related to the roof obtained from the application with a plurality of preset roof conditions.

10. The computer implemented system of claim 9, wherein the plurality of roof characteristics is identified by comparing a plurality of features identified from the series of time-lapse images of the roofs to a plurality of predefined roof features associated with a plurality of roof types stored in a dynamically updated database of the application based on a plurality of artificial intelligence-based instructions of the application.

11. The computer implemented system of claim 9, wherein the weather data includes a plurality of weather activities, including a plurality of hailstorm activities involving a plurality of hailstone with sizes capable of damaging the roof, heavy rain, wind, storm, lightning and other weather related activities capable of damaging the roof of the building within the geographical area.

12. The computer implemented system of claim 9, wherein the plurality of roof characteristics associated with the roof identified using the application includes a roof type, an age of the roof, at least one roof material, at least one roof dimension, at least one material covering the roof, at least one pre-existing roof damage related information and at least one maintenance information prior to the selected period of time and other related roof information relevant for determining the insurance eligibility status of the roof.

13. The computer implemented system of claim 9, wherein execution of the plurality of artificial intelligence-based instructions of the application enables an identification of the plurality of maintenance related information and the plurality of past and present damage related information associated with the roof during the selected period of time,
wherein the identification is performed by analyzing a plurality of sequential changes in a plurality of pixels in the series of time-lapse images and a plurality of changes in the roof characteristics and correlating with the weather activities during the selected period of time capable of damaging the roof.

14. The computer implemented system of claim 9, wherein the insurance eligibility status of the roof is determined by comparison of the plurality of information related to the roof obtained from the application with the plurality of preset roof conditions using the plurality of artificial intelligence-based instructions of the application.

15. The computer implemented system of claim 9, wherein the images are generated using multispectral imaging technology selected from the group consisting of infrared, ultra-violet and thermal imaging.
